(19) United States
(12) Patent Application Publication
(10) Pub. No.: US 2022/0299793 A1
(43) Pub. Date: Sep. 22, 2022

(54) Special eyeglass frame leveling device

(71) Applicant: Shelly Chamberlin, Anderson, IN (US)

(72) Inventor: Shelly Chamberlin, Anderson, IN (US)

(21) Appl. No.: 17/695,778

(22) Filed: Mar. 15, 2022

Related U.S. Application Data
(63) Continuation of application No. 63/161,497, filed on Mar. 16, 2021.

(51) Int. Cl. G02C 5/14

(52) U.S. Cl. CPC G02C 5/143

(57) ABSTRACT

A device that easily attaches to temples or frames of eyeglasses and can adjust the height from the ear to either left or right side to balance glasses; the device easily hides behind ear and is comfortable to wear for a long period of time and is universal to fit a wide variety of temple sizes; and includes an ear rest portion, a connection to the eyeglass templates and an optional manner to adjust the space between the ear and the templates.

### CROSS-REFERENCE TO RELATED APPLICATIONS

This application claims the benefit of United States Provisional Patent Application with Ser. No. 63/161,497 filed Mar. 16, 2021, by Shelly Chamberlin. The application was entitled “Special eye frame leveling device”.

### FIELD OF INVENTION

This invention relates to a special eyeglass frame leveling device. The embodiments described herein relate generally to mounting systems for eyewear, and more specifically to methods and apparatuses for leveling the templates on the ears of a user. This relates to an eyeglass system. This invention pertains to eyewear and more particularly, this invention relates to auxiliary devices attached to the frames for eyeglasses and eyeglass appliances. This invention relates to eyeglass means and more particularly to means to level the side pieces and to adjust the templates on the ear. This relates to eyeglass frame temples and more particularly to leveling devices placed onto the temples.

### FEDERALLY SPONSORED RESEARCH

None.

### SEQUENCE LISTING OR PROGRAM

None.

### BACKGROUND-FIELD OF INVENTION AND PRIOR ART

This section is not Applicable to Provisional Applications. However, as far as known, there are no special eyeglass frame leveling device or the like. It is believed that this product is unique in its design and technologies.

### BACKGROUND

This background as to eyeglasses and accessories should be useful. Spectacles are lens pieces embedded in a frame that are worn in front of the eyes to improve vision, protect the eyes, or for decorative purposes. Lenses can correct a variety of vision problems, including myopia, hyperopia, astigmatism, presbyopia, or strabismus. The glasses are composed of lenses and frame, and are divided into myopia glasses, hyperopia glasses, presbyopia glasses and astigmatic glasses, and there are also special glasses for watching 3D stereoscopic images or virtual real images. Other types of eyewear include goggles, sunglasses, swimming goggles, etc., which provide various types of protection to the eyes.

However, when the existing glasses are used, the situation that the templates are not level over the ears of the user. The user cannot modify the templates enough without damaging the glasses' frame or place the lenses at such an angle with the pupils of the eye to distort or mis-align the focal points of the lenses and pupils and thus make the correction to vision ineffective as well as leave the aesthetics of the glasses less than preferred. Most of the existing glasses need to go to a maintenance shop for attempting to properly bend and shape the templates and that maintenance cost is high.

A wide variety of improvements have been made in recent years in the eyewear field and provide a variety of functional improvements, such as maximizing interception of peripheral light, reducing optical distortion, and increasing the wearer's comfort level, compared to previous eyewear. However, adjustment to the temples for levelness with the ear location has yet to be effectively addressed. In addition, these non-level temples can result in optical distortion can result from the interaction of the lens with the frame, such as changes in the shape of the lens orbital or poor orientation of the lens with respect to the wearer's normal line of sight. Eyeglass systems which use a polymeric or metal wire frame are especially susceptible to bending and flexing due to a variety of environmental causes which further exacerbate the non-level conditions.

A further consideration in eyeglass design is the ease of interchangeability of the lens and/or ear stem/temples. Hence, with conventional eyeglasses, there is frequently a need to adjust the side pieces, so they will fit properly on the ear. It is generally difficult or impossible for the user to make these adjustments and this results in visits to the Optician.

### Problem Solved

Glasses sometimes do not fit square on face when temples are not in correct position and thus need to be adjusted on ear. The improvement and problem solved as the special eyeglass frame leveling device is as follows: aesthetically appealing and small enough that will be virtually unnoticeable; positions the eye glasses correctly on the face—not crooked; versatile and useable with all types of eye glasses with templates; simple; provides level condition for pupils and lenses so that the eyeglasses lens and pupil alignment is at its best because of level condition—this can assist with bi/tri-focal eyeglass wear (by shifting one side of the eyeglass wear up)—help pupils adjust/react and focus properly without of “double vision” and/or blurriness; saves time over trips to an optician; and Provides comfort from arm of eyeglass wear sitting directly on ear. Some arms of the eyeglasses can cause irritation sitting directly on the ear over a period of time.

### PRIOR ART

A novelty search revealed no other prior art that conflicts with this special eyeglass frame leveling device. The prior art found included:
A. Canadian Patent CA2275057 issued to Green et al., in 2008 for Eyewear with ear supports. It shows eyewear with earpieces supported from a wearer's ear with optional audio apparatus for use by the wearer, having a front frame brow piece portion including a front transparent panel that may be tinted and/or may be designed to correct vision impairments, being supported on a wearer's head by a nose bridge and by at least one earpiece or earplug that is received into the concha of the wearer's ear and/or into the ear canal. The earpiece or earplug is attached to a rear end of its respective temple of the eyewear and the respective temple for the earpiece or earplug is not supported over the wearer's ear. Preferably both temples are only supported by their respective rear earpiece or earplug. An over glasses embodiment is provided that can be worn over standard eyeglasses.
B. Chinese Patent CN210323629 in 2020 for a Glasses with wide application range. It demonstrates wide glasses of application scope, including picture frame, bridge and lens, picture frame, bridge and lens all are equipped with two sets of lens, and are two sets of be equipped with the tie-beam between the picture frame, the both ends of tie-beam are fixed with two sets of picture frame opposite sides respectively and bond, and are two sets of the mounting groove has all been opened to the inside wall of picture frame, and is two sets of the lens block is respectively installed in two sets of mounting grooves, the through-hole has all been opened to the lateral wall of picture frame both sides, the strip is accepted to the grafting installation in the through-hole at picture frame both ends, one side that the tie-beam is close to the bridge is through linking piece and two sets of bracket connection, the lateral wall of tie-beam is opened has and is.
C. Great Britain/United Kingdom Patent GB2413857 by Semenenko in 2009 for a Spectacles frames comprising telescopically adjustable side arms and nose bridge.
D. U.S. Pat. No. 3,118,962 by Hammond in 1964 for an ADJUSTABLE TEMPLE FOR EYEGLASSES. Here is taught an adjustable temple bar for eyeglass frames which is longitudinally adjustable in small increments, and which may readily be adjusted by the user.
E. U.S. Pat. No. 3,620,608 by Davis in 1971 for an Eyeglass assembly. Demonstrated is an improved eyeglass assembly that is provided in the form, for example, of a pair of spectacles having a resilient frame which may be composed of a light resilient plastic, and which includes side bows which are shaped and configured so that the assembly may be securely and firmly supported against the side of the head of the wearer and out of engagement with the bridge of the wearer's nose. In one embodiment, the side bows are adjustable to fit different head sizes.
F. U.S. Pat. No. 3,705,761 by Funisawa in 1972 for an Adjustable temple for eyeglasses. Shown here is an adjustable temple for eyeglasses that has a transversely notched front portion of an ear contoured part telescoped into a rearwardly open ended cavity portion of a forward part, and releasably locking member slidably positioned in a transverse open ended compartment in the forward part and in communication with the cavity portion, the locking member integrally including a detent shoulder, a spring member and an actuator end, whereby manual actuation of the actuator end moves the detent shoulder out of the notch against the action of the spring member, permitting manual longitudinal adjustment of the parts to fit different head sizes, and on release of the actuator end, the spring member forces the detent shoulder into an aligned notch to lock the parts together, providing individually adjusted eyeglasses.
G. U.S. Pat. No. 4,153,368 by Falbel et al., in 1979 for an Electro-optical detector protection device. This provides a protection device for an electro-optical detector used in systems for making far field diagnostic measurements of a high energy laser beam comprises a solid silicon cone having a truncated apex which functions as the pin hole aperture for the detector.
H. U.S. Pat. No. 4,306,779 by Rege in 1981 for a Side piece for spectacle frame. Here is taught a side piece for a spectacle frame, adapted to take a normal position with slight horizontal clearance and a firm holding position in which the curved rear tip is applied against the ear, wherein said side piece is formed by a sheath in which slides a piece which is urged by a spring in the direction of the lens-bearing face and which is normally immobilized by a blade abutting against a fixed socket. A push button enables the piece to be released when desired.
I. U.S. Pat. No. 4,787,727 by Boodman in 1988 for a Means to adjust eyeglasses. Demonstrated in this patent is a pair of eyeglasses having side members which hook over the user's ear. An adjustment is provided to adjust the length of the side pieces. The adjustment may be screw type adjusting means or ratchet type adjusting means. An adjustment is also provided to adjust a side hinge to vary the pressure of a side piece against the head.
J. U.S. Pat. No. 5,359,370 by Mugnier in 1994 for a multi-component eyewear. Described is an eyewear system that is designed to improve the comfort, fit, functionality, and modularity of the eyewear. Features include a 180.degree. reflex spring hinge which improves comfort, fit, and safety; a sway-hinge mechanism that allows the temples to be independently adjusted to improve comfort and fit of the eyewear behind the ears; a strap-pad which has been ergonomically designed to fit different shaped and sized noses and can be positioned for wearer comfort and convenience; a frame and lens construction that allows for modularity by the easy removal and replacement of the lens, temples, tops of frames, and nose pieces; and accessories that can be added to the eyewear to provide a greater degree of comfort and to protect the face from ultraviolet radiation and the wind.
K. U.S. Pat. No. 5,883,688 by Chao in 1999 for an Eyeglass frame with arms and flaps. Shown here is an eyeglass apparatus that includes a primary frame having two side studs for pivotally coupling two legs. An auxiliary frame for disposing in front of the primary frame includes two sides each having an extension for engaging with the outer portion of the leg. The extensions each includes a magnet for engaging with another magnet engaged in the leg or with the magnetic leg and for securing the auxiliary frame to the primary frame. The extensions each includes a clamping member for securing to the legs without the magnets.
L. U.S. Pat. No. 7,140,728 by McKenna et al., in 2006 for a Method of forming magnetic eyeglass appliance. This invention is about an eyeglass accessory frame which includes an auxiliary frame. The auxiliary frame includes a heat-treated magnetic alloy. The heat-treated magnetic alloy of the auxiliary frame is configured to magnetically couple the auxiliary frame to a primary frame having magnetizable material.
M. U.S. Pat. No. 9,465,238 by Mazzola in 2016 for an Eyeglass system and method of use. Here is shown an eyeglass system having a frame, left and right-side shields connected to the frame at inset locations from the edge of the frame, arms connected to the side shields, and user select mechanisms for releasing the arms from a retracted position to a protracted position. The protracted position allows the length of the arms to be long enough for the temple tips to rest over the ears of the wearer while the retracted position allows the arms and side shields to close without the left side arm extending past the right-side edge of the frame and the right-side arm from extending past the left side edge of the frame in the closed position.
N. U.S. Pat. No. 10,359,642 by Calilung et al., in 2019 for a Mounting mechanism for eyewear. This demonstrates an eyewear which can be provided that comprises at least one lens, at least one ear stem, and a frame with components that interconnect two or more components of the eyewear. The components can include an engagement structure of the lens and a coupling mechanism attached to the frame. The coupling mechanism can include a housing configured to receive the engagement protrusion and a lever mechanism being operative to move between open and closed positions for disengaging or engaging with the engagement protrusion.
O. World Patent disclosure WO1990009611 by Stemme et al., submitted in 1990 for a Fastening arrangement. This shows a fastening arrangement for fastening accessories to ophthalmic devices, in particular spectacles, by means of permanent magnets. Permanent magnets which possess high magnetic characteristic values such as energy density and remanence are obtained by using alloys containing at least one rare earth element and/or cobalt and/or by making them magnetically anisotropic. This reduces the volume and weight of the permanent magnets, which can therefore be advantageously mounted in spectacle frames, while ensuring reliable fastening of the accessory.

As can be observed, none of the prior art has anticipated or caused one skilled in the art of eye glass accessories and temple devices to see this concept and invention by Shelly Chamberlin. The device provides an answer to a safe, compact, and simple device for leveling eyeglasses for better use and aesthetics.

### SUMMARY OF THE INVENTION

This invention is special eyeglass frame leveling device. Taught here are the ways a device to help level eyeglass devices for better use and aesthetics. The preferred embodiment of a special eyeglass frame leveling device is comprised of a slot type device with a slot opening slit having sides; having a slot aperture/void for temple; and an ear rest wherein the slot device is slid over at least one temple 50 of eyeglasses and placed above an ear of a user to level the temple with respect to ground. An alternative is a special eyeglass frame leveling device is comprised of an aperture of concentric device for temple with a slot aperture and an ear rest wherein the slot device is slid over at least one temple of eyeglasses and placed above an ear of a user to level the temple with respect to ground. The newly invented special eyeglass frame leveling device can be manufactured at low volumes by very simple means and in high volume production by more complex and controlled systems.

### OBJECTS AND ADVANTAGES

There are several objects and advantages of the special eyeglass frame leveling device. There are currently no known eye frame leveling or temple accessory devices that are effective at providing the objects of this invention. The special eyeglass frame leveling device has various advantages and benefits:

| Item | Uses/Advantages |
|---|---|
| 1 | Is aesthetically appealing -small enough that will |
| | be virtually unnoticeable |
| 2 | Keeps the glasses/sunglasses positioned |
| | correctly on the face - not crooked |
| 3 | Can be used for all eyeglass wear - glasses, |
| | sunglasses, reading glasses, in all types and |
| | sizes |
| 4 | Has at least two (2) variations for personal |
| | preference |
| 5 | Provides simplicity - very easy to use and place |
| | on the arm of the eyeglass wear (by all ages) |
| 6 | Is affordable - very inexpensive |
| 7 | Keeps glasses in place from sliding down the nose |
| | (constantly having to push the glasses up) |
| 8 | Eliminates issues with ill-fitting eyeglass wear |
| | that may not work their best because of fit. Not |
| | only a nuisance, but possibly limiting ability to |
| | see clearly |
| 9 | Maintains a tight hold on the eyeglass arm to stay |
| | in place for even the most active people. Help |
| | keep glasses in place during activity |
| 10 | Can assist with bi/tri-focal eyeglass wear (by |
| | shifting one side of the eyeglass wear up) - help |
| | pupils adjust/react and focus properly without of |
| | “double vision” and/or blurriness |
| 11 | Is a time/money saver - reduce need to return to |
| | optometrist for adjustments |
| 12 | Eliminates the issue with the eyeglass wear types |
| | that are resistant to manual adjustment (titanium, |
| | memory plastic and aluminum alloy, to name a few) |
| 13 | Is a universal configuration and can fit a wide |
| | variety of temple sizes. |
| 14 | Provides comfort from arm of eyeglass wear sitting |
| | directly on ear. Some arms of the eyeglasses can |
| | cause irritation sitting directly on the ear over |
| | a period of time. |

Finally, other advantages and additional features of the present special eyeglass frame leveling device will be more apparent from the accompanying drawings and from the full description of the device. For one skilled in the art of accessories and template devices for eyeglasses, it is readily understood that the features shown in the examples with this product are readily adapted to other types of eye glass devices.

### DESCRIPTION OF THE DRAWINGS—FIGURES

The accompanying drawings, which are incorporated in and constitute a part of this specification, illustrate an embodiment of the special eyeglass frame leveling device that is preferred. The drawings together with the summary description given above and a detailed description given below explain the principles of the special eyeglass frame leveling device. It is understood, however, that the special eyeglass frame leveling device is not limited to only the precise arrangements and instrumentalities shown.

FIGS. 1A through 1 E are sketches of the special eyeglass frame leveling device.

FIG. 2 is a sketch of the general original concepts for the eye frame leveling device with components and features noted.

FIGS. 3A through 3 D are sketches of the slot type and concentric type of the eye frame leveling device with the components and features noted.

FIGS. 4A through 4 E are sketches of the prototype slot and concentric type devices.

FIGS. 5A through 5 F are sketches of the eye glass leveling devices with elongated ear rests.

FIGS. 6A through 6 F are sketches of the device in use on the templates.

FIGS. 7A through 7 D are sketches of the eye glass level device in use.

FIGS. 8A through 8 E are sketches of prior art devices for eye glass templates.

### DESCRIPTION OF THE DRAWINGS—REFERENCE NUMERALS

The following list refers to the drawings:

TABLE B
Reference numbers

| Ref # | Description |
|---|---|
| 30 | special eyeglass frame leveling device 30 |
| 33 | prototype 33 of a special eyeglass frames |
| | leveling device 30 |
| 35 | original sketches 35A and 35B of a special |
| | eyeglass frame leveling device 30 |
| 40 | slot type device 40 |
| 41 | slot opening slit 41 with sides 41A, 41B |
| 42 | slot aperture/void 42 for temple 50 |
| 43 | ear rest 43 |
| 44 | ear rest depth 44 |
| 45 | concentric device 45 |
| 46 | aperture 46 of concentric device 45 for temple 50 |
| 46A | slot cross section 46A of horizontal rectangle |
| | for aperture 46 |
| 46B | slot cross section 46B of vertical rectangle for |
| | aperture 46 |
| 46C | slot cross section 46C of square for aperture 46 |
| 46D | slot cross section 46D of ellipse for aperture 46 |
| 46E | slot cross section 46E of circle for aperture 46 |
| 47 | configuration 47 of ear rest 44 |
| 47A | flat configuration 47A |
| 47B | ellipse configuration 47B |
| 47C | “vee” configuration 47C |
| 47D | tread configuration 47D |
| 47E | dimple configuration 47E |
| 50 | eyeglass temple member 50 |
| 51 | ear end 51 |
| 52 | lenses end 52 |
| 60 | squeeze lock device 60 with top 66 notch only |
| 61 | top structure 61 of squeeze lock device 60 |
| 62 | left and right squeeze points 62A and 62B of the |
| | top structure 61 of squeeze lock device 60 |
| 63 | post 63 from ear rest 68 to top/aperture end 65 |
| 63A | means to secure 63A such as integral molding, |
| | adhesive, heat weld, mechanical fastener, clip, |
| | or the like |
| 64 | post 64 from top structure 61 with configuration |
| | of aperture 69 which encompasses or encircles |
| | aperture end 65 |
| 65 | aperture end 65 of post 63 which slidably |
| | interferes with aperture of a top structure 61 |
| 66 | top 66 notch |
| 67 | pliable ledge 67 of top notch 66 to releasably |
| | hold eyeglass temple member 50 |
| 68 | ear rest structure 68 secured to post 63 by a |
| | means to secure 63A |
| | left and right ends 68A and 68B of ear rest 68 |
| 69 | aperture configuration 69 of a top structure 61 |
| | which mates with post end 65 (cross section may |
| | be square, round, oval; or the like) |
| R | Radiused R portion of ear rest structure 68 |
| 70 | squeeze lock device 70 with optional bottom |
| | recess 75 |
| 75 | optional bottom recess 75 |
| 80 | Prior Art 80 U.S. Pat. No. 4,153,348 by Falbel et |
| | al., issued in 1979 and entitled Electro-optical |
| | detector protection device |
| 81 | Prior Art 81 U.S. Pat. No. 10,359,642 by Calilung et |
| | al., issues in 2019 was called a Mounting |
| | mechanism for eyewear |
| 82 | Prior Art 82 U.S. Pat. No. 3,705,761 by Funisawa was |
| | issued in 1972 and titled an Adjustable temple |
| | for eyeglasses |
| 83 | Prior Art 83 U.S. Pat. No. 2,413,857 by Semenenko was |
| | issued in 2009 for a Spectacles frames comprising |
| | telescopically adjustable side arms and nose |
| | bridge |
| 84 | Prior Art 84 U.S. Pat. No. 2,278,057 by Green et al., |
| | in 2008 for Eyewear with ear supports |
| 100 | user/person 100 |
| 105 | ear 105 of user 100 |

### DETAILED DESCRIPTION OF PREFERRED EMBODIMENT

This invention relates to a special eyeglass frame leveling device. The embodiments described herein relate generally to mounting systems for eyewear, and more specifically to methods and apparatuses for leveling the templates on the ears of a user. This relates to an eyeglass system. This invention pertains to eyewear and more particularly, this invention relates to auxiliary devices attached to the frames for eyeglasses and eyeglass appliances. This invention relates to eyeglass means and more particularly to means to level the side pieces and to adjust the templates on the ear. This relates to eyeglass frame temples and more particularly to leveling devices placed onto the temples. A device that easily attaches to temples or frames of eyeglasses and can adjust the height from the ear to either left or right side to balance glasses; the device easily hides behind ear and is comfortable to wear for a long period of time and is universal to fit a wide variety of temple sizes; and includes an ear rest portion, a connection to the eyeglass templates and an optional manner to adjust the space between the ear and the templates.

The advantages for the special eyeglass frame leveling device 30 are listed above in the introduction. Succinctly the benefits are that the device:
A. Is aesthetically appealing—small enough that will be virtually unnoticeable;
B. Keeps the glasses/sunglasses positioned correctly on the face—not crooked;
C. Can be used for all eyeglass wear—glasses, sunglasses, reading glasses, in all types and sizes;
D. Has at least two (2) variations for personal preference;
E. Provides simplicity—very easy to use and place on the arm of the eyeglass wear (by all ages);
F. Is affordable—very inexpensive;
G. Keeps glasses in place from sliding down the nose (constantly having to push the glasses up);
H. Eliminates issues with ill-fitting eyeglass wear that may not work their best because of fit. Not only a nuisance, but possibly limiting ability to see clearly;
I. Maintains a tight hold on the eyeglass arm to stay in place for even the most active people. Help keep glasses in place during activity;
J. Can assist with bi/tri-focal eyeglass wear (by shifting one side of the eyeglass wear up)—help pupils adjust/react and focus properly without of “double vision” and/or blurriness;
K. Is a time/money saver—reduce need to return to optometrist for adjustments;
L. Eliminates the issue with the eyeglass wear types that are resistant to manual adjustment (titanium, memory plastic and aluminum alloy, to name a few);
M. Is a universal configuration and can fit a wide variety of temple sizes; and
N. Provides comfort from arm of eyeglass wear sitting directly on ear. Some arms of the eyeglasses can cause irritation sitting directly on the ear over a period.

The preferred embodiment of the special eyeglass frame leveling device 30 is comprised of a slot type device 40 with a slot opening slit 41 having sides 41A, 41B; having a slot aperture/void 42 for temple 50; and an ear rest 43 wherein the slot device is slid over at least one temple 50 of eyeglasses and placed above an ear of a user to level the temple with respect to ground. The alternative is a special eyeglass frame leveling device 30 is comprised of an aperture 46 of concentric device 45 for temple 50 with a slot aperture 46 and an ear rest 43 wherein the slot device is slid over at least one temple 50 of eyeglasses and placed above an ear of a user to level the temple with respect to ground. An alternative embodiment is a special eyeglass frame leveling squeeze device 30,60 made of durable materials and comprised of: (a) a top structure 61 of squeeze device 30,60 with a left and a right squeeze point 62A,62B and a post 64 extending downward from the top structure 61, the said post 64 with configuration of aperture 69 which can encompasses or encircles an aperture end 65 of an ear rest 68; (b) a top structure 61 of squeeze lock device 30,60 further comprised of a top 66 notch and a pliable ledge 67 of top notch 66 to releasably hold eyeglass temple member 50; (c) a means to secure 63A the said ear rest 68 to the aperture end 65; and (d) the said ear rest 68 to the aperture end 65 further comprised a radiused R portion of ear rest structure 68 and a set of left and right ends 68A,68B of the ear rest 68 wherein the device 30,60 is slid over at least one temple 50 of eyeglasses and placed above an ear 105 of a user 100 to level the temple with respect to ground and wherein the post 63 can be slid up and down within the aperture 69 to adjust the distance of offset from an ear 105 for the user 106.

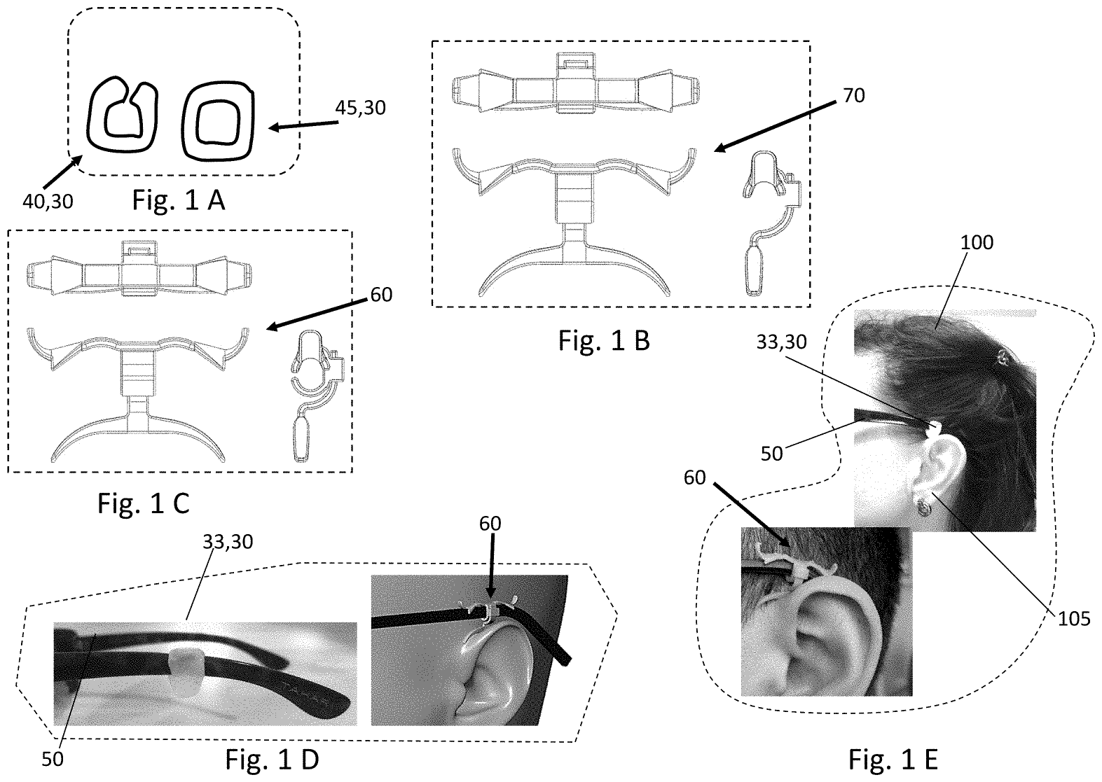

There is shown in FIGS. 1-8 a complete description and operative embodiment of the special eyeglass frame leveling device 30. In the drawings and illustrations, one notes well that the FIGS. 1-8 demonstrate the general configuration and use of this product. The various example uses are in the operation and use section, below.

The accompanying drawings, which are incorporated in and constitute a part of this specification, illustrate an embodiment of the special eyeglass frame leveling device 30 that is preferred. The drawings together with the summary description given above and a detailed description given below explain the principles of the special eyeglass frame leveling device 30. It is understood, however, that the special eyeglass frame leveling device 30 is not limited to only the precise arrangements and instrumentalities shown. Other examples of eye glass accessories and template component devices and uses are still understood by one skilled in the art of accessories for eyeglasses to be within the scope and spirit shown here.

FIGS. 1A through 1 E are sketches of the special eyeglass frame leveling device 30. Shown in this summary page are as follows: a special eyeglass frame leveling device 30; a prototype 33 of a special eyeglass frame leveling device 30; a slot type device 40; a concentric device 45; an eye glass temple member 50; a squeeze lock device 60 with top 66 notch only; a squeeze lock device 70 with optional bottom recess 75; a user/person 100; and an ear 105 of user 100. These are further described in the other views.

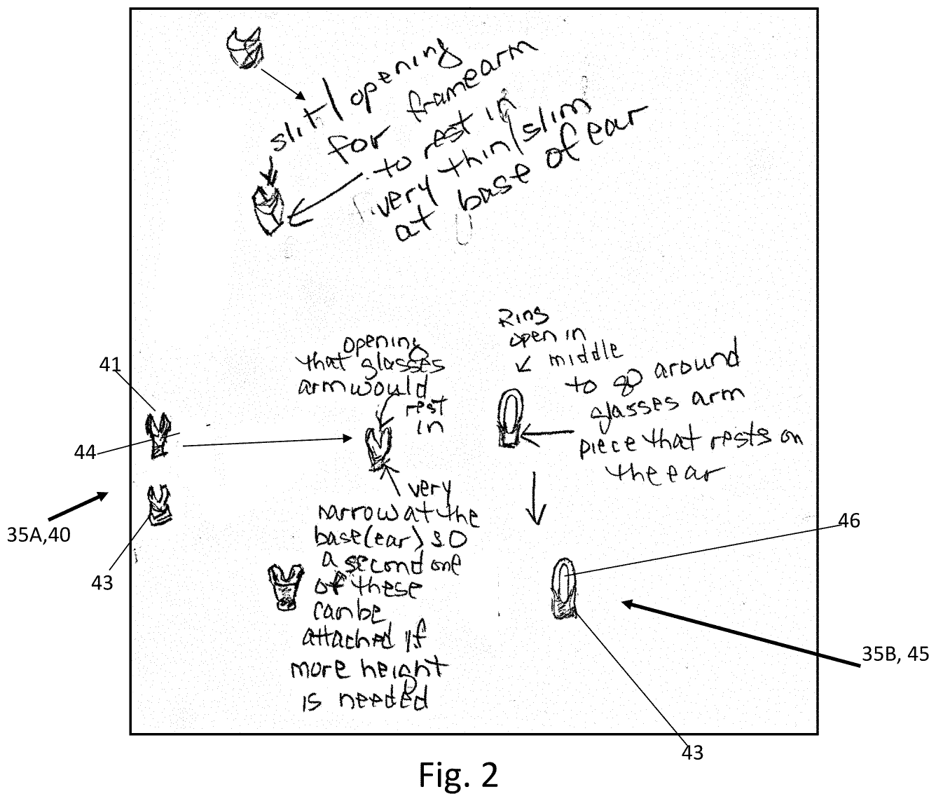

FIG. 2 is a sketch of the general original concepts 35A, 35B for the eye frame leveling device 30 with components and features noted. Provided in these original sketches of the concept are a special eyeglass frame leveling device 30; an original sketches 35A and 35B of a special eyeglass frame leveling device 30; a slot type device 40; a slot opening slit 41; an ear rest 43; an ear rest depth 44; a concentric device 45; and an aperture 46 of concentric device 45 for temple 50.

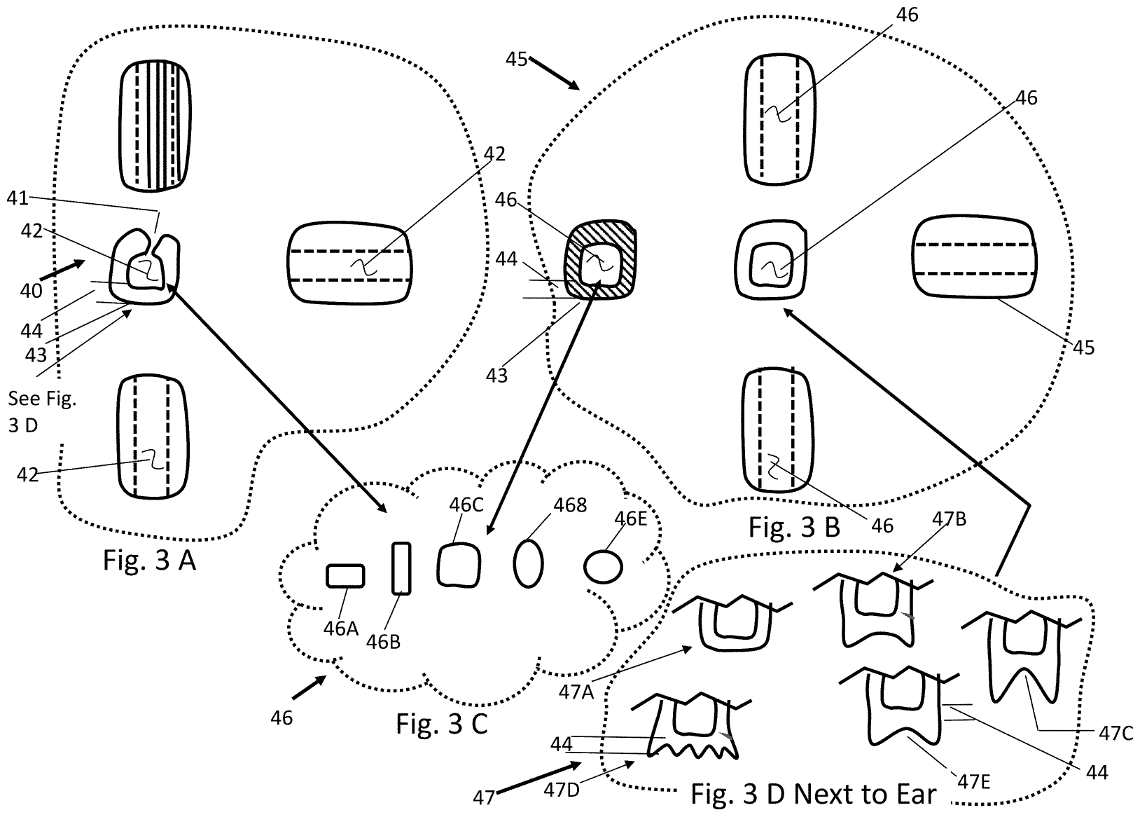

FIGS. 3A through 3 D are sketches of the slot type 40 and concentric type 45 of the eye frame leveling device 30 with the components and features noted. Demonstrated in these drawings include: a slot type device 40; a slot opening slit 41 with sides 41A, 41B; a slot aperture/void 42 for temple 50; an ear rest 43; an ear rest depth 44; a concentric device 45; an aperture 46 of concentric device 45 for temple 50; a slot cross section 46A of horizontal rectangle for aperture 46; a slot cross section 46B of vertical rectangle for aperture 46; a slot cross section 46C of square for aperture 46; a slot cross section 46D of ellipse for aperture 46; a slot cross section 46E of circle for aperture 46; a configuration 47 of ear rest 44; a flat configuration 47A; an ellipse configuration 47B; a “Vee” configuration 47C; a tread configuration 47D; a dimple configuration 47E; an eye glass temple member 50; an ear end 51; and a lenses end 52. The devices 30, 40, 45 are anticipated to be made from a durable, soft material such as, for example and not as a limitation, memory plastic, rubber, synthetic rubber, nylon, polyester thermoplastic, “Instamorph”®, alloy silicones, composite materials, elastomeric polymers, or the like.

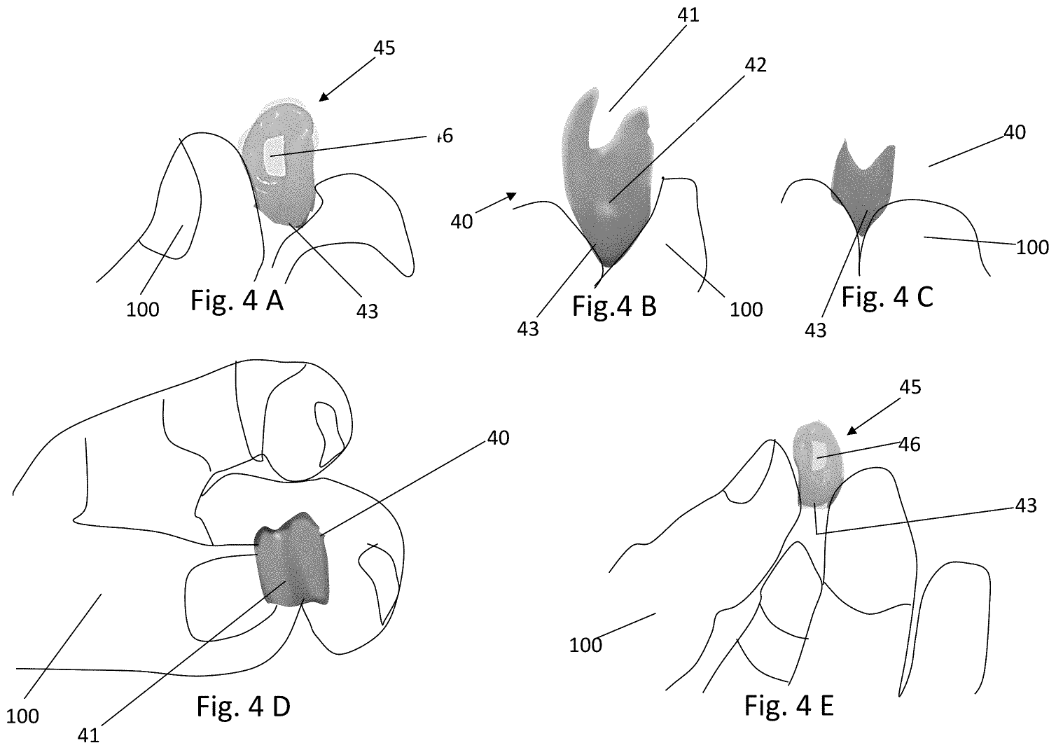

FIGS. 4A through 4 E are sketches of the prototype 33 slot 40 and concentric 45 type devices 30. Portrayed and shown here are a prototype 33 of a special eyeglass frame leveling device 30; a slot type device 40; a slot opening slit 41 with sides 41A, 41B; a slot aperture/void 42 for temple 50; an ear rest 43; a concentric device 45; and an aperture 46 of concentric device 45 for temple 50.

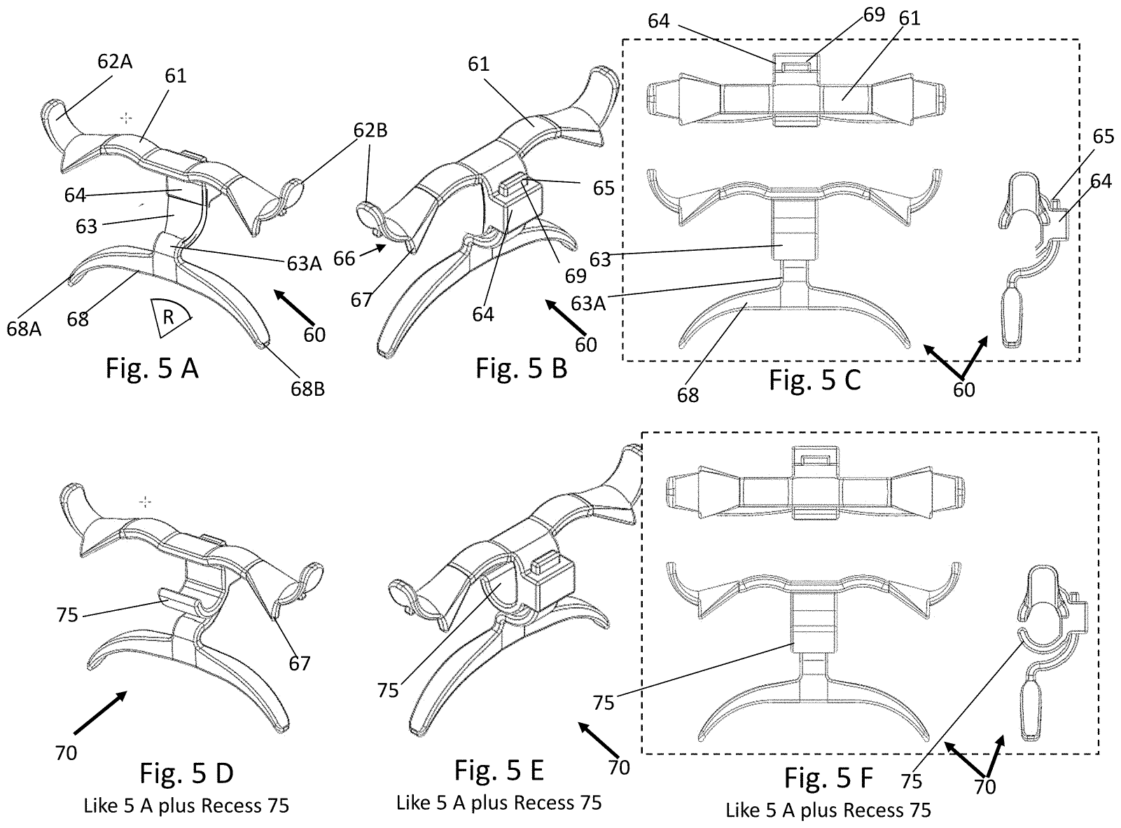

FIGS. 5A through 5 F are sketches of the eye glass leveling devices with elongated ear rests. Shown and demonstrated here are: a squeeze lock device 60 with top 66 notch only; a top structure 61 of squeeze lock device 60; a left and right squeeze points 62A and 62B of the top structure 61 of squeeze lock device 60; a post 63 from ear rest 68 to top/aperture end 65; a means to secure 63A such as integral molding, adhesive, heat weld, mechanical fastener, clip, or the like; a post 64 from top structure 61 with configuration of aperture 69 which encompasses or encircles aperture end 65 an aperture configuration 69 of the top structure 61; an aperture end 65 of post 63 which slidably interferes with an aperture of the top structure 61; a top 66 notch; a pliable ledge 67 of top notch 66 to releasably hold eyeglass temple member 50; an ear rest structure 68 secured to post 63 by a means to secure 63A; a set of left and right ends 68A and 68B of ear rest 68; an aperture configuration 69 which mates with post end 65 (cross section may be square, round, oval; or the like); a radiused R portion of ear rest structure 68; a squeeze lock device 70 with optional bottom recess 75; and an optional bottom recess 75.

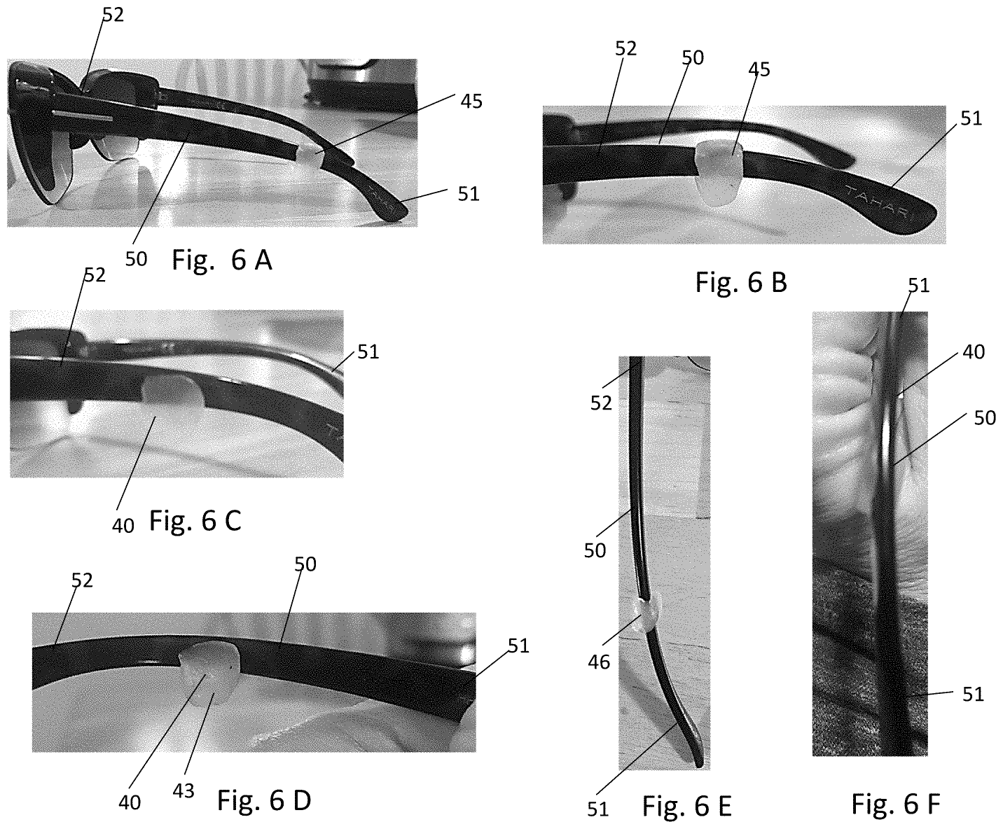

FIGS. 6A through 6 F are sketches of the device 30, 40, 45 in use on the templates 50. Shown are a slot type device 40; a concentric device 45; an eye glass temple member 50; an ear end 51; a lens end 52, and a person/user 100.

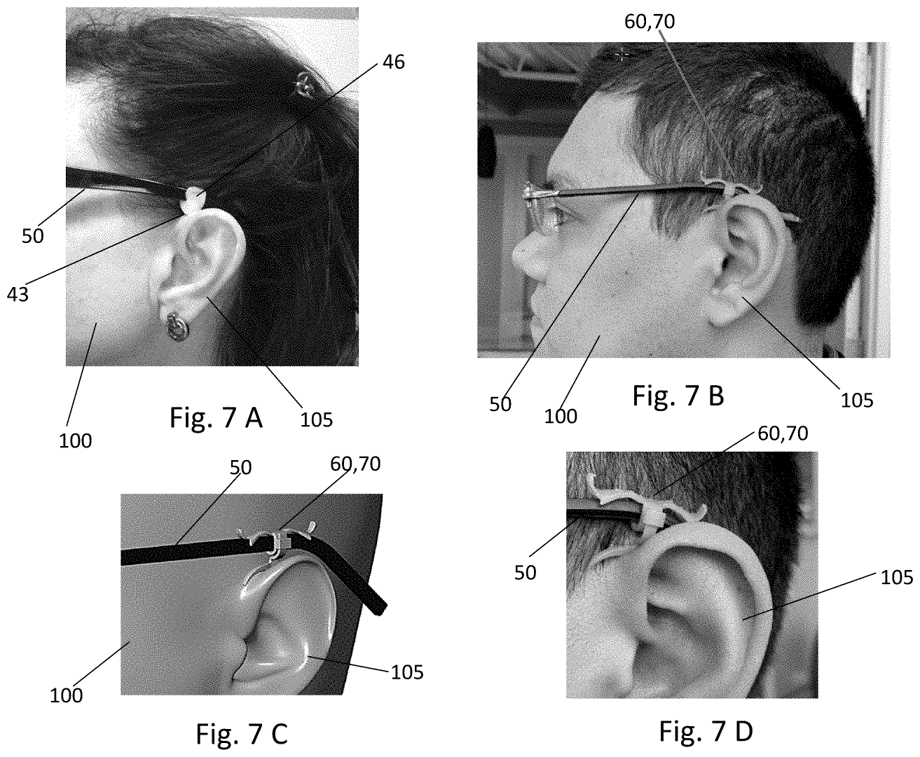

FIGS. 7A through 7 D are sketches of the eye glass level device in use. This is described in the Operation Section below.

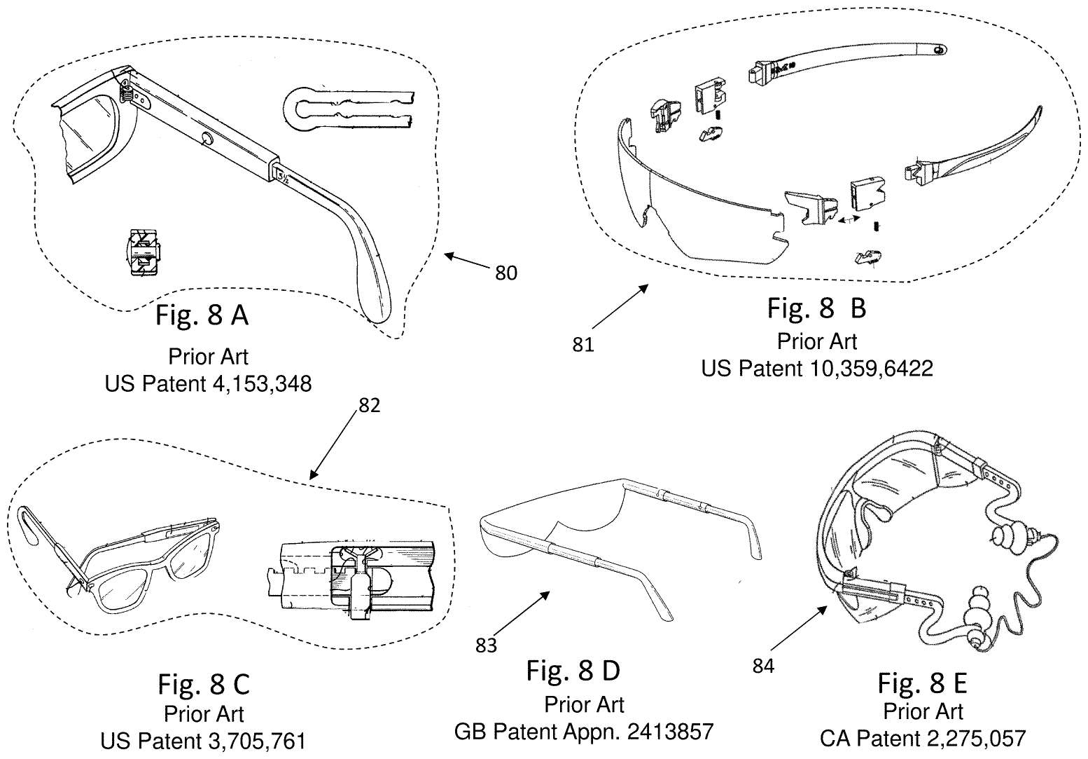

FIGS. 8A through 8 E are sketches of prior art devices for eye glass templates. Here former patents and applications for various eye glass and temple devices and the like. These include: Prior Art 80 U.S. Pat. No. 4,153,348 by Falbel et al., issued in 1979 and entitled Electro-optical detector protection device; Prior Art 81 U.S. Pat. No. 10,359,642 by Calilung et al., issues in 2019 was called a Mounting mechanism for eyewear; Prior Art 82 U.S. Pat. No. 3,705,761 by Funisawa was issued in 1972 and titled an Adjustable temple for eyeglasses; Prior Art 83 U.S. Pat. No. 2,413,857 by Semenenko was issued in 2009 for a Spectacles frames comprising telescopically adjustable side arms and nose bridge; and Prior Art 84 U.S. Pat. No. 2,278,057 by Green et al., in 2008 for Eyewear with ear supports. As can be seen, the special eyeglass frame leveling device is a unique combination and use as described herein.

The details mentioned here are exemplary and not limiting. Other specific components and manners specific to describing a special eyeglass frame leveling device 30 may be added as a person having ordinary skill in the field of the art of eye glass accessories and template devices and their uses well appreciates.

### Operation of the Preferred Embodiment

The special eyeglass frame leveling device 30 has been described in the above embodiment. The manner of how the device operates is described below. One notes well that the description above and the operation described here must be taken together to fully illustrate the concept of the special eyeglass frame leveling device 30. The preferred embodiment of the special eyeglass frame leveling device 30 is comprised of a slot type device 40 with a slot opening slit 41 having sides 41A, 41B; having a slot aperture/void 42 for temple 50; and an ear rest 43 wherein the slot device is slid over at least one temple 50 of eyeglasses and placed above an ear of a user to level the temple with respect to ground. The alternative is a special eyeglass frame leveling device 30 is comprised of an aperture 46 of concentric device 45 for temple 50 with a slot aperture 46 and an ear rest 43 wherein the slot device is slid over at least one temple 50 of eyeglasses and placed above an ear of a user to level the temple with respect to ground.

The special eyeglass frame leveling device 30 operates in a simple manner. For the slot type device 40 with a slot opening slit 41 and sides 41A, 41B, the slit 41 is slid over the template 50 at the ear end 51 of the eyeglasses of the user 100. Note that the template 50 is inserted until it fills the slot aperture/void 42 for temple 50. The configuration 47 of ear rest 44 is placed contiguous to the ear 105 of the user 100. This is repeated for the second template if necessary. For the concentric device 45, the template 50 is slid into the aperture 46 of concentric device 45 at the ear end 51 of the template 50. It is slid forward toward the lenses end 52 until the concentric device 45 is located above the ear 105 of the user 100—again with the ear rest 44 contiguous with the top of the ear 105. And again, this is repeated for the second template if necessary. For the a squeeze lock device 60 with top 66 notch only and the a squeeze lock device 70 with optional bottom recess 75 the left and right squeeze points 62A and 62B of the top structure 61 of squeeze lock device 60 are brought slightly together which opens the top 66 notch and a pliable ledge 67 of top notch 66 to releasably hold eyeglass temple member 50. Then the temple 50 is slid into the opening of the pliable ledge 67. Next the post 63 from ear rest 68 is slid up or down with the interference fit of the top/aperture end 65 and the aperture configuration 69 which mates with post end 65 (cross section may be square, round, oval; or the like) of the top structure 61 of squeeze lock device 60. The amount up and down is at the preference of the user 100. Note that the post 63 can be slid up and down within the aperture 69 to adjust the distance 44 of offset for the user 100. And again, this is repeated for the second template if necessary. For the squeeze lock device 70 with optional bottom recess 75 the operation is similar with the temple 50 also engaged with the optional bottom recess 75.

FIGS. 7A through 7 D are sketches of the eye glass level device 30 in use. Here the above procedure is used, and results are shown as: an ear rest 43; an aperture 46 of concentric device 45 for temple 50; an eye glass temple member 50; a squeeze lock device 60 with top 66 notch only; a squeeze lock device 70 with optional bottom recess 75; a user/person 100; and an ear 105 of user 100.

Many uses are anticipated for the special eyeglass frame leveling device 30. Some examples, and not limitations, are shown in the following Table.

| ITEM | DESCRIPTION |
|---|---|
| 1 | Typical eyeglasses with various types of templates |
| 2 | Eyeglasses with bi focal and tri focal lenses to aid |
| | alignment of the pupils and lenses of the eyeglasses |
| 3 | Sport glasses to aid alignment of the lenses and |
| | pupils for aim |
| 4 | Reading glasses to aid alignment of the lenses and |
| | pupils for aim |
| 5 | Work glasses to aid focus and alignment of the |
| | lenses, pupils, and work piece |

With this description it is to be understood that special eyeglass frame leveling device 30 is not to be limited to only the disclosed embodiment of product. The features of the special eyeglass frame leveling device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another to form varying modes of the disclosed inventions. Thus, it is intended that the scope of at least some of the present inventions herein disclosed should not be limited by the particularly disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any embodiment, feature, or combination of features shown herein. This is true even if only a single embodiment of the feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed considering the number of recited significant digits and by applying ordinary rounding techniques.

The present invention contemplates modifications as would occur to those skilled in the art. While the disclosure has been illustrated and described in detail the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. A special eyeglass frame leveling device (30,40) made of durable materials and comprised of:
a slot type device (40) with a slot opening slit (41) having sides (41A, 41B); having a slot aperture/void (42) for temple (50); and having an ear rest (43)
wherein the slot device is slid over at least one temple (50) of eyeglasses and placed above an ear (105) of a user (100) to level the temple with respect to ground.

2. The special eyeglass frame leveling device (30,40) in claim 1 wherein the durable material is selected from the group consisting of memory plastic, rubber, synthetic rubber, nylon, polyester thermoplastic, “Instamorph”®, alloy silicones, composite materials, and elastomeric polymers.

3. A special eyeglass frame leveling slot device (30,45) is comprised of: an aperture (46) of concentric device (45) of a given shape for temple (50) with an aperture (46) and an ear rest (43) wherein the slot device is slid over at least one temple (50) of eyeglasses and placed above an ear of a user to level the temple with respect to ground.

4. The special eyeglass frame leveling slot device (30,45) in claim 3 wherein the durable material is selected from the group consisting of memory plastic, rubber, synthetic rubber, nylon, polyester thermoplastic, “Instamorph”®, alloy silicones, composite materials, and elastomeric polymers.

5. The special eyeglass frame leveling slot device (30,45) in claim 3 wherein the given shape of the aperture (46) is selected from the group consisting of a horizontal rectangle (46A), a vertical rectangle (46B), a square (46C), an ellipse (46D), and a circle (46E).

6. A special eyeglass frame leveling squeeze device (30,60) made of durable materials and comprised of:
(a) a top structure (61) of squeeze device (30,60) with a left and a right squeeze point (62A,62B) and a post (64) extending downward from the top structure (61), the said post (64) with configuration of aperture (69) which can encompasses or encircles an aperture end (65) of an ear rest (68);
(b) a top structure (61) of squeeze lock device (30,60) further comprised of a top (66) notch and a pliable ledge (67) of top notch (66) to releasably hold eyeglass temple member (50);
(c) a means to secure (63A) the said ear rest (68) to the aperture end (65); and
(d) the said ear rest (68) to the aperture end (65) further comprised a radiused (R) portion of ear rest structure (68) and a set of left and right ends (68A,68B) of the ear rest (68)
wherein the device (30,60) is slid over at least one temple (50) of eyeglasses and placed above an ear (105) of a user (100) to level the temple with respect to ground and wherein the post (63) can be slid up and down within the aperture (69) to adjust the distance of offset from an ear (105) for the user (106).

7. The special eyeglass frame leveling squeeze device (30,60) in claim 6 wherein the durable material is selected from the group consisting of memory plastic, rubber, synthetic rubber, nylon, polyester thermoplastic, “Instamorph”®, alloy silicones, composite materials, and elastomeric polymers.

8. The special eyeglass frame leveling squeeze device (30,60) in claim 6 wherein the given cross section of the aperture (69) and post (63) is selected from the group consisting of a circle, a square, and an ellipse.

9. The special eyeglass frame leveling squeeze device (30,60) in claim 6 wherein the means to secure (63A) the said ear rest (68) to the aperture end (65) is selected from the group consisting of an integral molding, an adhesive, a heat weld, a mechanical fastener, and a clip.

10. The special eyeglass frame leveling squeeze device (30,60,70) in claim 6 further comprised of a bottom recess (75).
